(19) United States
(12) Patent Application Publication
(10) Pub. No.: US 2022/0274437 A1
(43) Pub. Date: Sep. 1, 2022

(54) ADJUSTABLE FOLDER

(71) Applicant: IdeaStream Consumer Products, LLC, Cleveland, OH (US)

(72) Inventor: Eric Fitzgerald Klosky, Chagrin Falls, OH (US)

(21) Appl. No.: 17/746,061

(22) Filed: May 17, 2022

Related U.S. Application Data
(63) Continuation-in-part of application No. 29/771,482, filed on Feb. 23, 2021.
(60) Provisional application No. 63/189,313, filed on May 17, 2021.

(51) Int. Cl. B42F 7/02

(52) U.S. Cl. CPC B42F 7/02

(57) ABSTRACT

A file folder that is configured to be sized to accommodate letter-size paper or sized to accommodate A4 or legal-size paper. As such, a single fold can be configured by a user to be used with a desired size of paper.

The present disclosure is a continuation-in-part of U.S. patent application Ser. No. 29/771,482 filed Feb. 23, 2021, which is fully incorporated by reference herein.

The present disclosure claims priority on U.S. Provisional Patent Application Ser. No. 63/189,313 filed May 17, 2021, which is fully incorporated by reference herein.

### FIELD OF THE DISCLOSURE

The present disclosure relates generally to file folders. Some exemplary file folders are of the type referred to as “manila” file folders. The file folders are configured to be sized to accommodate letter-size paper or sized to accommodate A4 or legal-size paper.

### BACKGROUND OF THE DISCLOSURE

Manila folders are commonly cut to hold either letter size or legal size paper. As such two sets of folders are required for inventory to accommodate these different paper sizes.

### SUMMARY OF DISCLOSURE

The present disclosure relates generally to file folders that are configured to be sized to accommodate letter-size paper or sized to accommodate A4 or legal-size paper. As such, a single fold can be configured by a user to be used with a desired size of paper.

The file folder, which can be formed form one or more pieces of material, may be folded in multiple directions and along multiple fold locations to produce folders that are configured to accommodate letter-size paper or A4 or legal-size paper. As such, only one type of folder (and one type of folder die) is required that can be used with the common paper sizes of letter, A4 and legal. This simplifies manufacturing and stocking and helps prevent a common situation of running out of file folders.

In one non-limiting aspect of the present disclosure, there is provided a sheet for a folder. The sheet of material has a top surface, a bottom surface, top and bottom edges, first and second side edges, and optional first and second tabs. The optional first tab is located on the top edge and the optional second tab is located on the bottom edge. The sheet of material includes a first center fold line that extends between the first and second side edges. The first center fold line is positioned generally parallel to one or both of the top and bottom edges. The first center fold line is spaced from the top edge a distance that is about 30-75% of a total distance between the top and bottom edges. The sheet of material includes a first side fold line that extends between the top and bottom edges. The first center fold line intersects the first side fold line at a location that is spaced from the second side edge. Generally, such angle of intersection is 80-110° (and all values and ranges therebetween, 90°). When the folder includes a second center fold line, the second center fold line intersects the first side fold line at a location that is spaced from the second side edge. Generally, such angle of intersection is 80-110° (and all values and ranges therebetween, 90°). The first side fold line is positioned generally parallel to one or both of the first and second side edges. The first side fold line is positioned closer to the second side edge than to the first side edge. The first side fold line is spaced from the second side edge a distance that is about 5-40% of a total distance between the first and second side edges. When the folder optionally includes a second side fold line, the second side fold line is spaced from the first side fold line, is spaced closer to the second side edge than the first side fold line, is spaced from the second side edge, and is generally parallel to the first side fold line. The one or more center fold lines also intersect the optional second side fold line at an angle of intersection of 80-110° (and all values and ranges therebetween, 90°).

The folder is foldable along the first center fold line to form a file folder. When the file folder includes the optional first and/or second tabs, the first and/or second tabs each extend opposite the central fold. A bottom portion of the sheet of material is foldable along the first side fold line to optionally adjust a length of the sheet of material prior to folding the sheet of material along the first center fold line.

In another non-limiting aspect of the present disclosure, the first center fold line can be formed of at least one depression and/or serrated region that is located on one or both the top and bottom surfaces of the sheet of material.

In another non-limiting aspect of the preset disclosure, the first side fold line is formed of at least one depression and/or serrated region that is located on one or both the top and bottom surfaces of the sheet of material.

In another non-limiting aspect of the present disclosure, wherein the sheet of material can optionally include one or more of a) a first fastener positioned between the first center fold line and the top edge; wherein the first fastener optionally includes a first mount portion and two bendable arms that are connected to and extending from the first mount; and wherein the two bendable arms are optionally spaced from the first center fold line and the top edge; and wherein the two bendable arm of the first fastener are located above the top surface of the sheet of material; and b) a second fastener positioned between the first center fold line and the bottom edge; and wherein the second fastener optionally includes a second mount portion and two bendable arms connected to and extending from the second mount; and wherein the two bendable arms are optionally spaced from the first center fold line and the bottom edge; and wherein the two bendable arms of the second fastener are located above said top surface of said sheet of material.

In another non-limiting aspect of the present disclosure, wherein the sheet of material further includes a second center fold line. The second center fold line is spaced from the first center fold line. The second center fold line is positioned generally parallel to the first center fold line. The second center fold line extends between the first and second side edges. The second center fold line is positioned generally parallel to one or both of the top and bottom edges. The second center fold line is spaced from the top edge a distance that is about 30-75% of a total distance between the top and bottom edges.

In another non-limiting aspect of the present disclosure, wherein the sheet of material optionally includes a second center fold line that is formed of at least one depression and/or serrated region that is located on both the top and bottom surfaces of the sheet of material.

In another non-limiting aspect of the present disclosure, wherein the sheet is optionally made from a single piece of material and optionally from a single die cut.

In another non-limiting aspect of the present disclosure, there is provided a kit that includes a) one or more sheets of material for a folder; and b) instructions for i) folding at least one of the sheets of material along a center fold line to form a folder, and/or ii) folding at least one of said sheet along said first side fold line prior to folding at least one of said sheets of material along a center fold line to form a folder.

In another non-limiting aspect of the present disclosure, there is provided a method for forming a folder comprising providing a sheet of material; and folding the sheet of material along a first center fold line to form a folder.

In another non-limiting aspect of the present disclosure, there is provided a method for forming a folder comprising folding the sheet of material along a first side fold line prior to folding the folder along the first center fold line.

### BRIEF DESCRIPTION OF THE DRAWINGS

Reference may now be made to the drawings, which illustrate various embodiments that the disclosure may take in physical form and in certain parts and arrangements of parts wherein:

FIG. 1 is a front perspective view of an adjustable folder illustrating one non-limiting embodiment wherein the bottom flap is folded;

FIG. 2 is a front elevational view of the adjustable folder of FIG. 1;

FIG. 3 is a rear elevational view of the adjustable folder of FIG. 1;

FIG. 4 is a right side plan view of the adjustable folder of FIG. 1;

FIG. 5 a left side plan view of the adjustable folder of FIG. 1;

FIG. 6 is a top plan view of the adjustable folder of FIG. 1;

FIG. 7 is a bottom plan view of the adjustable folder of FIG. 1;

FIG. 8 is a front perspective view of the adjustable folder of FIG. 1 wherein the bottom flap is unfolded;

FIG. 9 is a front elevational view of the Adjustable folder of FIG. 8;

FIG. 10 is a rear elevational view of the Adjustable folder of FIG. 8;

FIG. 11 is a right side plan view of the Adjustable folder of FIG. 8;

FIG. 12 a left side plan view of the Adjustable folder of FIG. 8;

FIG. 13 is a top plan view of the Adjustable folder of FIG. 8; and

FIG. 14 is a bottom plan view of the Adjustable folder of FIG. 8.

### DETAILED DESCRIPTION OF NON-LIMITING EMBODIMENTS

A more complete understanding of the articles/devices, processes, and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

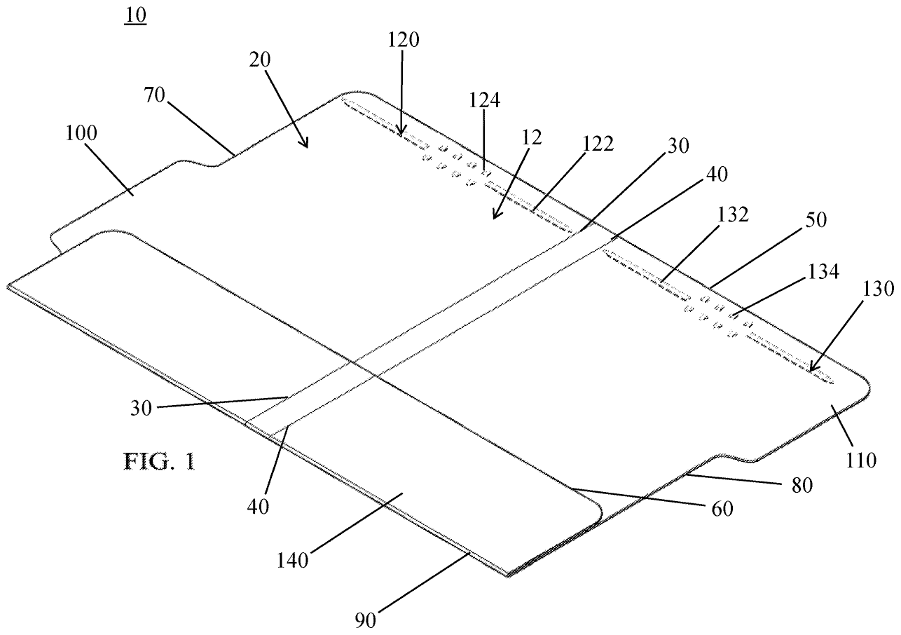

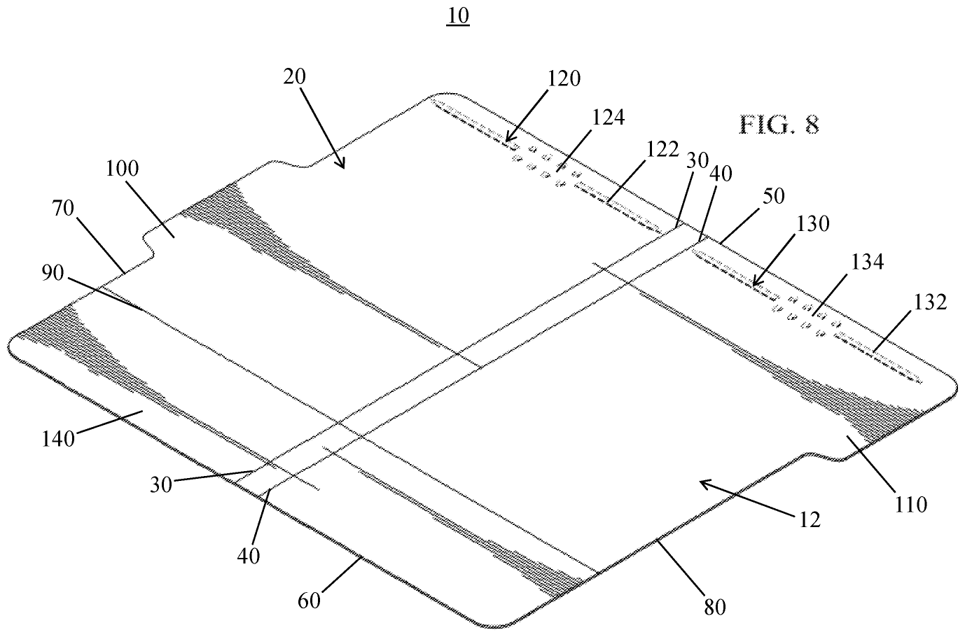

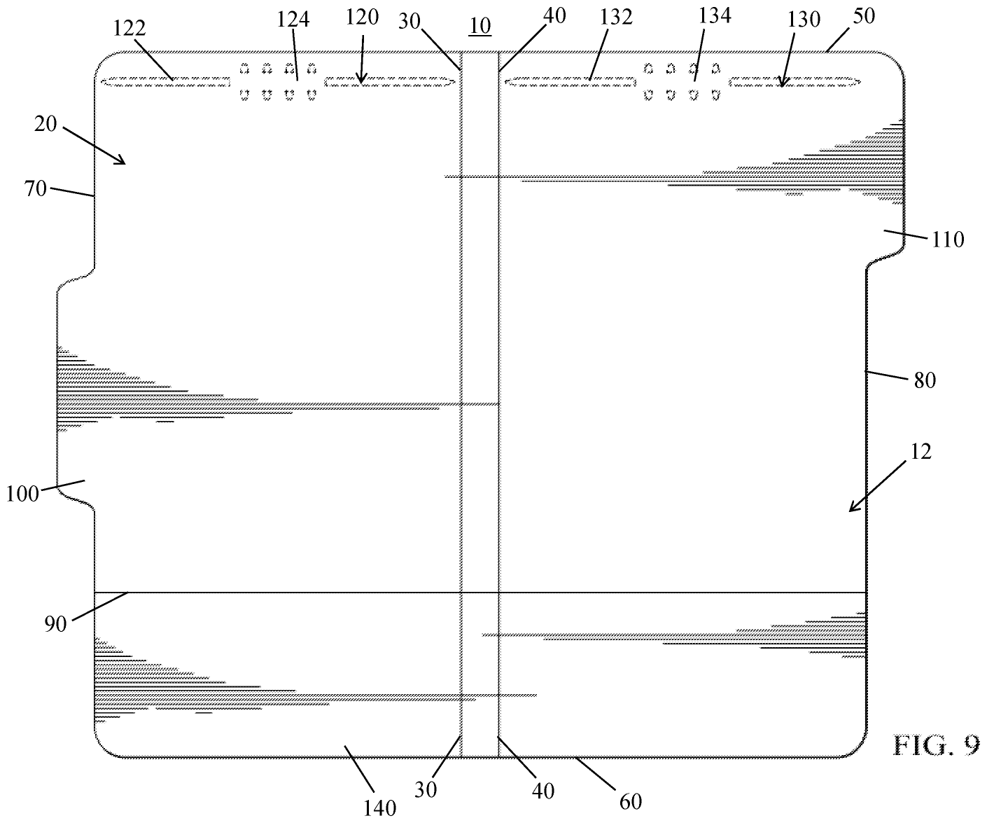

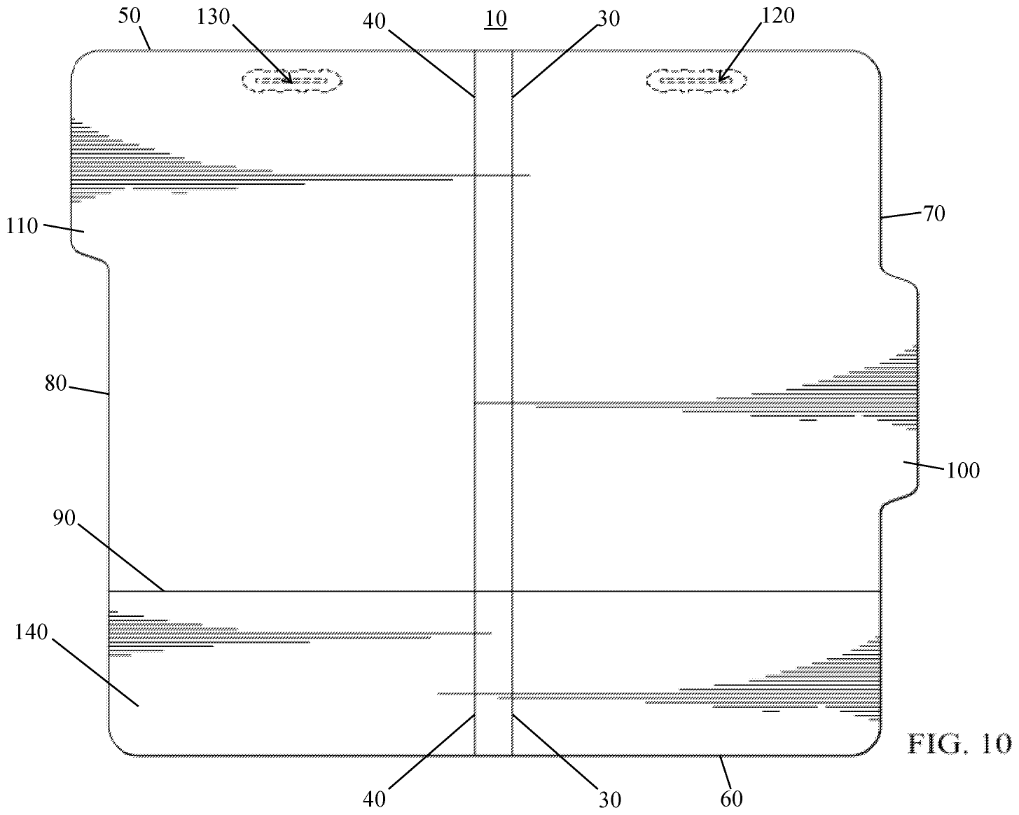

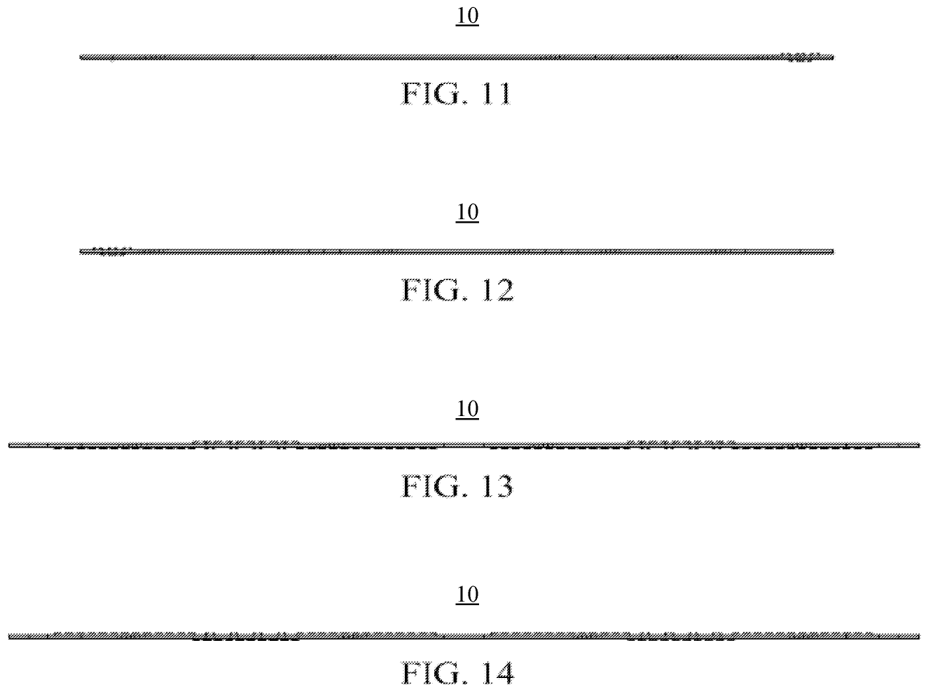

The figures illustrated an exemplary file folder 10 in accordance with the present disclosure. Referring now to FIGS. 1 and 8, the exemplary file folder 10 may comprise a single sheet of material 20 having one or more central folds 30, 40, a first side edge 50, and a second side edge 60, a top edge 70, a bottom edge 80, and a side fold line 90 that is spaced from the second edge 60. As can be appreciated, the folder 10 can be formed of a plurality of pieces that are connected together.

Generally, the folder 10 is formed of a paper material (e.g., paper board, fiber board, corrugated paper, etc.); however other materials can be used (e.g., plastic, metal, etc.). One or more portion of the folder 10 can be formed of a single layer of material, or be formed of two or more layers of material that are connected together (e.g., adhesively connected together, melt bonded together, press bonded together, etc.). In one non-limiting embodiment, the folder 10 is formed of a paper board material, and 50%-100% (and all values and ranges therebetween) of the folder is formed of a single layer of paper board. The color of the folder 10 is non-limiting. On e or more sides of the folder can include the same or different colors and/or the same or different designs.

The thickness of the folder 10 is non-limiting. Generally, the thickness of the folder 10, when not folded, is about 0.002-0.25 inches (and all values and ranges therebetween). In one non-limiting embodiment, the average thickness of the folder 10, when not folded, is 0.01-0.05 inches.

The folder 10 can optionally include a tab 100 on the top edge 70. Likewise, the folder 10 can optionally include a tab 110 on the bottom edge 80. Generally, when the top edge 70 and bottom edge 80 both include a tab 100, 110, the two tabs are positioned such that when the file folder 10 is folded along one of the central folds 30, 40, the tabs are partially or fully offset from one another; however, this is not required. In one non-limiting arrangement, when the top edge 70 and bottom edge 80 both include a tab 100, 110, the two tabs are positioned such that when the file folder 10 is folded along one of the central folds 30, 40, only 0-90% (and all values and ranges therebetween) of the tabs 100, 110 overlap one another, typically only 0-50% of the tabs 100, 110 overlap one another, and more typically only 0-25% of the tabs 100, 110 overlap one another. As best illustrated in FIG. 8, a first end of tab 110 terminates at first side edge 50 and the second end of tab 110 is spaced from second side edge 60. As can be appreciated, tab 110 can be positioned such that the first end is spaced from first side edge 50, and the second end of tab 110 is spaced form or terminates at second side edge 60. As illustrated in FIG. 1, when a portion of the bottom portion of folded along a side fold line 90 to form fold over portion 140, a portion of one or both of tabs 100, 110 can optionally be positioned such that 0-100% (and all values and ranges therebetween) of the width of the fold over portion 140 is located adjacent to all or a portion of tabs 100, 110. In one non-limiting embodiment, 5-60% of the width of the fold over portion 140 is located adjacent to at least one of tabs 100, 110.

Positioned on or spaced from the first side edge 50 are optionally one or more fasteners 120, 130 that can be used to secure papers and other items (e.g., pouches, envelopes, etc.) to the folder 10. The one or more fasteners 120, 130 are generally spaced from the one or more central folds 30, 40; however, this is not required. The one or more fasteners 120, 130 are also generally spaced from the first side edge 50; however, this is not required. The one or more fasteners 120, 130 are also generally spaced from the top and bottom edges 70, 80; however, this is not required.

As illustrated in FIGS. 1 and 8, the one or more fasteners 120, 130 are at least partially connected to top surface 12 of the folder 10; however, this is not required. The connection arrangement used to secure the one or more fasteners 120, 130 to the folder 10 is non-limiting (e.g., adhesive, slots, clamping arrangement, etc.).

As also illustrated in FIGS. 1 and 8, at least a majority of the fastener 120, 130 is positioned on the top surface 12 of the folder 10. In one non-limiting arrangement, each fastener does not overlie any portion of the central folds 30, 40. Each fastener 120, 130 generally includes two bendable arms 122, 132, and a mount arrangement 124, 134 that is located between the two bendable arms. The two bendable arms 122, 132 for each of fasteners 120, 130 the can be part of a single piece of material (e.g., metal, plastic, etc.); however, this is not required. The structure of the fasteners 120, 130 and the arrangement used to secure the fasteners 120, 130 to the folder 10 are well known in the art, thus will not be described further herein. Generally, one or both of the fasteners 120, 130 are spaced closer to the first side edge 50 than to the second side edge 60. In one non-limiting embodiment, the one or both of the fasteners 120, 130 are spaced from the first side edge 50 a distance of 0-15% (and all values and ranges therebetween) of a total distance between the first and second side edges 50, 60; and typically, the one or both of the fasteners 120, 130 are spaced from the first side edge 50 a distance of 0.5-5% of a total distance between the first and second side edges 50, 60. Generally, the two bendable arms 122, 132 are orientated generally parallel to the first side edge 50; however, this is not required.

The folder 10 generally has a height between at least one of the central folds 30, 40 and at one of each of the first and second side edges 70, 80 when the folder 10 is folded along one of the central folds 30, 40 of about 4-15 inches (and all values and ranges therebetween), and typically, about 8-11 inches.

In one non-limiting embodiment, when the folder 10 includes a single central fold, the central fold is optionally spaced an equal distance from the first and second side edges 70, 80 such that when the folder 10 is folded along such central fold, at least a portion or all of the first and second edges 70, 80 (that are absent the optional tabs) are positioned parallel to one another and spaced 0-0.5 inches (and all values and ranges therebetween) from one another.

In another non-limiting embodiment, when the folder 10 includes two or more central folds, generally, one of the central folds is optionally spaced an equal distance from the first and second side edges 70, 80 such that when the folder 10 is folded along such central fold, at least a portion or all of the first and second edges 70, 80 (that are absent the optional tabs) are positioned parallel to one another and spaced 0-0.5 inches (and all values and ranges therebetween, 0-0.25 inches) from one another. In another non-limiting embodiment, when the one of the central folds are spaced a non-equal distance from the first and second side edges such that when the folder is folded along such central fold, at least a portion of the first edge (that is absent the optional tab) is spaced at least some distance (e.g., 0.1-2 inches and all values and ranges therebetween, 0.5-1.5 inches) above or below and second edge (that is absent the optional tab).

The one or more central folds 30, 40 and/or the one or more side fold lines 90 are generally formed by one or more depressions and/or serrated regions in the top and/or bottom surface of the folder 10. The one or more depressions and/or serrated regions can be formed by pressing, stamping, cutting, etching and/or the like. The size, width and depth of the one or more depressions and/or serrated regions are non-limiting. In one non-limiting embodiment, the size, width and/or depth of the depression that is used to form each of the center fold lines and side fold lines are the same. In another non-limiting embodiment, the size, width and/or depth of the depression that is used to form each of the center fold lines and side fold lines are different. In another non-limiting embodiment, the width of the depression that is used to form each of the center fold lines and side fold lines is 0.001-0.1 inches (and all values and ranges therebetween). In another non-limiting embodiment, the depth of the depression that is used to form each of the center fold lines and side fold lines is 0.001-0.1 inches (and all values and ranges therebetween).

In one non-limiting embodiment, the depression and/or serrated region for one or more or all of the one or more central folds 30, 40 and/or the one or more side fold lines 90 are formed only in the top surface 12 of the folder 10 and are absent from the bottom surface 14 of the folder 10.

In another non-limiting embodiment, the depression and/or serrated region for one or more or all of the one or more central folds 30, 40 and/or the one or more side fold lines 90 are formed only in the bottom surface 14 of the folder 10 and are absent from the top surface 12 of the folder 10; however, this is not required.

In another non-limiting embodiment, the spacing between the two or more central folds 30, 40 is generally 0.25-2 inches (and all values and ranges therebetween). In one non-limiting embodiment, the folder includes only two center fold lines and the spacing between the two center fold lines is 0.3-1.25 inches. In one non-limiting configuration, the distance between center fold line 30 and top edge 70 is the same distance as the distance between center fold line 40 and bottom edge 80. In another non-limiting configuration, the distance between center fold line 30 and top edge 70 is less than the distance between center fold line 40 and bottom edge 80. In another non-limiting configuration, the distance between center fold line 30 and top edge 70 is greater than the distance between center fold line 40 and bottom edge 80.

In another non-limiting embodiment, the depression and/or serrated region for one or more or all of the one or more central folds 30, 40 and/or the one or more side fold lines 90 are formed in both the top surface 12 and the bottom surface 14 of the folder 10; however, this is not required.

When the folder 10 includes two or more central folds 30, 40, at least two or all of the central folds are parallel to one another; however, this is not required. When the folder includes two or more side fold lines, at least two or all of the side fold lines are parallel to one another; however, this is not required. Generally one end of the one or more central folds intersects with one or all of the side fold lines. Generally the one or more side fold lines are oriented 80-100° (and all values and ranges therebetween) to the one or more central folds, and typically the one or more side fold lines are oriented about 90° to the one or more central folds. Generally, the one or more side fold lines are oriented parallel to the first side edge 50 and/or second side edge 60.

As best illustrated in FIG. 8, the one or more side fold lines 90 are generally spaced from at least one or all of the one or more optional tabs 100, 110 on the top edge 70 and bottom edge 80. Generally, one or all of the one or more side fold lines are spaced closer to the second side edge 60 than to the first side edge 50. In one non-limiting embodiment, the spacing of side fold line 90 from second side edge 60 is 5-40% (and all values and ranges therebetween) of a total distance between the first and second side edges 50, 60; and typically, the spacing of side fold line 90 from second side edge 60 is 5-25% of a total distance between the first and second side edges 50, 60.

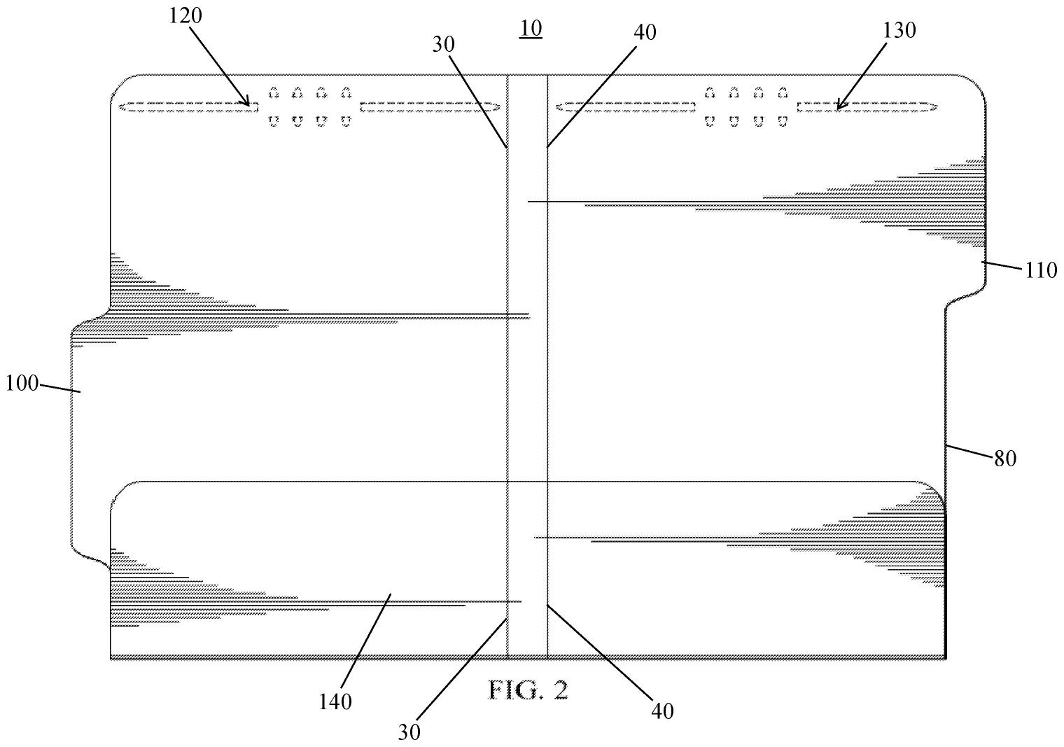

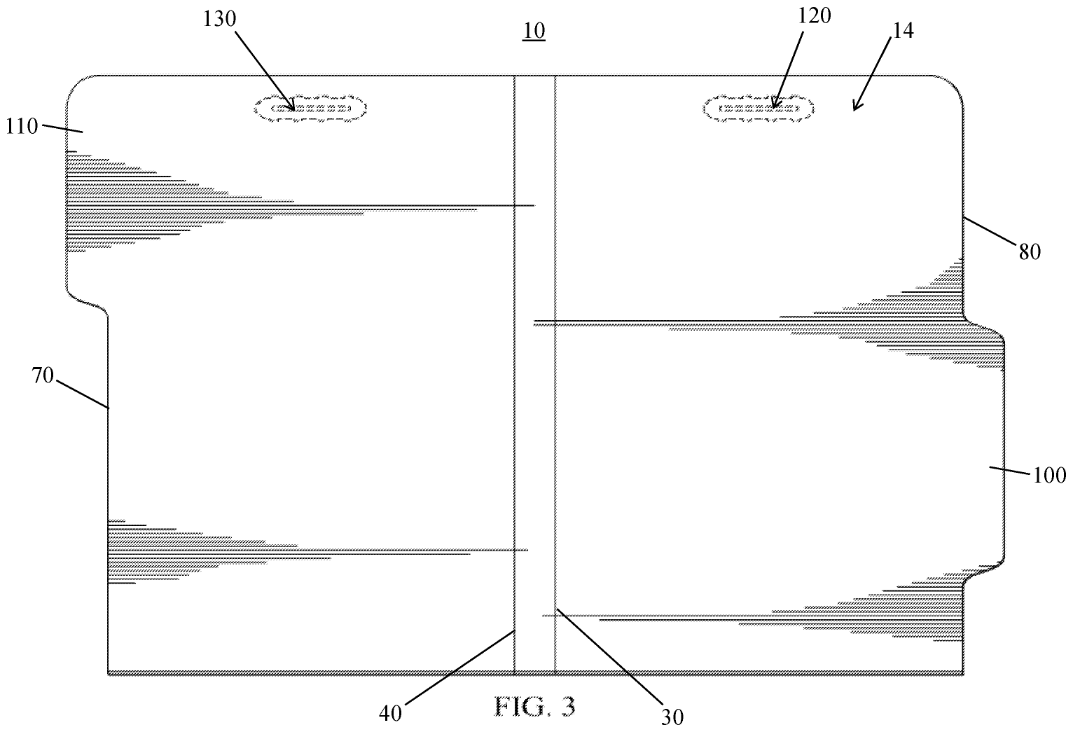

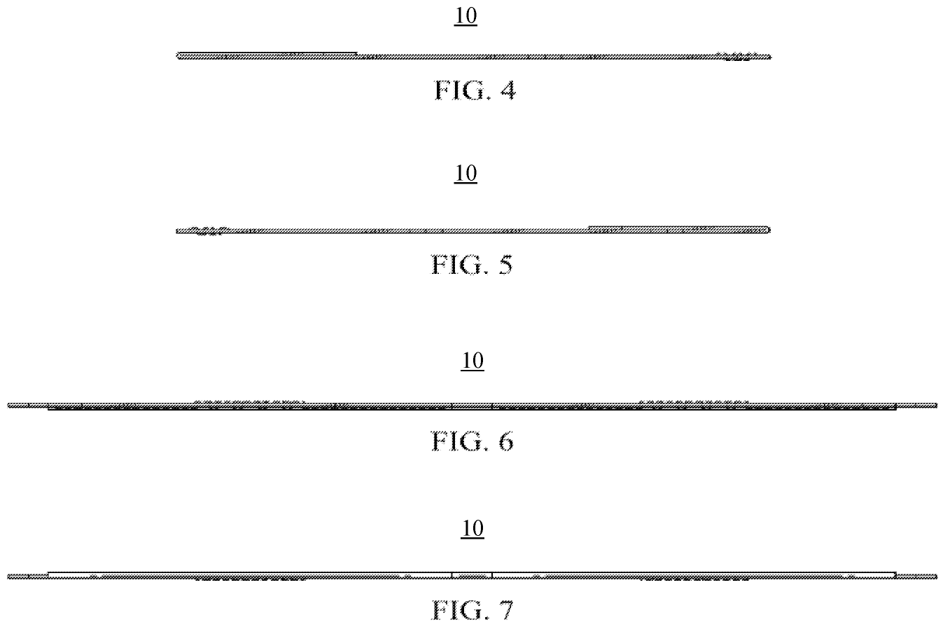

As illustrated in FIGS. 1 and 2, when a portion of the bottom portion of the folder 10 is folded along one of the one or more side fold lines 90, a fold over portion 140 is formed. The width of the fold over portion 140 is generally about 1-5 inches (and all values and ranges therebetween) or about 5-40% (and all values and ranges therebetween) of the total unfolded length of the folder 10 between the first side edge 50 and second side edge 60. When the folder 10 is configured for legal sized paper or A4 paper, the length of the folder between the first side edge 50 and second side edge 60, when a portion of the bottom portion of the folder 10 is not folded along one or more of the side fold lines 90 as illustrated in FIG. 8, is about 14-17 inches (and all values and ranges therebetween); and when the folder 10 is configured for letter sized paper, and the length between first side edge 50 and the side fold line 90, when a portion of the bottom portion is folded along the side fold line 90 as illustrated in FIG. 1, is about 11-13 inches (and all values and ranges therebetween).

The length of the one or more optional tabs 100, 110 is generally about 5-70% (and all values and ranges therebetween) the length of each of the top edge 70 or bottom edge 80, typically the length of the one or more optional tabs 100, 110 is about 5-50% the length of each of the top edge 70 or bottom edge 80, and more typically length of the one or more optional tabs 100, 110 is about 10-45% the length of each of the top edge 70 or bottom edge 80. The length of tabs 100, 110 can be the same or different. The width of tabs 100, 110 can be the same or different. In one non-limiting embodiment, the length and width of tabs 100, 110 is the same.

As best illustrated in FIG. 8, one or more of the corners of the folder 10 can optionally be curved; however, this is not required. The radius of curvature of the one or more rounded corners is generally 0.25-2 inches (and all values and ranges therebetween).

The folder 10 can optionally include a label holder and/or an embossed region that is designated to receive a label. The label holder and/or an embossed region can be located on the one or more tabs or one the bottom surface 14 of the folder 10.

The folder can optionally include one or more pockets formed on the top surface of the folder 10.

When the folder 10 is configured for legal and letter sized paper, the folder 10 can be packaged in a non-folded orientation as illustrated in FIG. 8 or can be folded along one of the center fold lines. When the folder 10 is used for legal paper, the fold over portion 140 is not folded along the side fold line prior to the folder 10 being folded along a center fold line. If the folder 10 is optionally package as already being folded along one of the center fold lines, then no further folding of the folder 10 is required for use with legal sized paper.

When the folder 10 is used for letter paper, the fold over portion 140 is folded along the side fold line prior to the folder 10 being folded along a center fold line. If the folder 10 is package as already being folded along the center fold line, the folder 10 is unfolded along the center fold line, then the fold over portion 140 is folded along the side fold line, and the folder 10 is refolded along a center fold line.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the preferred embodiments. These and other modifications of the preferred embodiments as well as other embodiments of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

What is claimed:

1. A sheet for a folder comprising:
a sheet of material having a top surface, a bottom surface, top and bottom edges, first and second side edges, and first and second tabs; said first tab located on said top edge and said second tab located on said bottom edge; said sheet of material including a first center fold line extending between said first and second side edges; said first center fold line positioned generally parallel to one or both of said top and bottom edges; said first center fold line spaced from said top edge a distance that is about 30-75% of a total distance between said top and bottom edges; said sheet of material including a first side fold line that extends between said top and bottom edges; said first center fold line intersecting said first enter fold line at a location that is spaced from said second side edge; said first side fold line positioned generally parallel to one or both of said first and second side edges; said first side fold line positioned closer to said second side edge than to said first side edge; said first side fold line spaced from said second side edge a distance that is about 5-40% of a total distance between said first and second side edges; and
wherein said folder is foldable along said first center fold line into a file folder having said first and second tabs each extending opposite said central fold;
wherein a bottom portion of said sheet of material is foldable along said first side fold line to adjust a length of said sheet of material prior to folding said folder along said first center fold line.

2. The sheet for a folder as defined in claim 1, wherein said first center fold line is formed of at least one depression and/or serrated region that is located on both said top and bottom surfaces of said sheet of material.

3. The sheet for a folder as defined in claim 1, wherein said first side fold line is formed of at least one depression and/or serrated region that is located on one or both said top and bottom surfaces of said sheet of material.

4. The sheet for a folder as defined in claim 2, wherein said first side fold line is formed of at least one depression and/or serrated region that is located on one or both said top and bottom surfaces of said sheet of material.

5. The sheet for a folder as defined in claim 1, further including one or more of a) a first fastener positioned between said first center fold line and said top edge; said first fastener including a first mount portion and two bendable arms connected to and extending from said first mount; said two bendable arms spaced from said first center fold line and said top edge; said two bendable arm of said first fastener located above said top surface of said sheet of material; and b) a second fastener positioned between said first center fold line and said bottom edge; said second fastener including a second mount portion and two bendable arms connected to and extending from said second mount; said two bendable arms spaced from said first center fold line and said bottom edge; said two bendable arms of said second fastener located above said top surface of said sheet of material.

6. The sheet for a folder as defined in claim 4, further including one or more of a) a first fastener positioned between said first center fold line and said top edge; said first fastener including a first mount portion and two bendable arms connected to and extending from said first mount; said two bendable arms spaced from said first center fold line and said top edge; said two bendable arm of said first fastener located above said top surface of said sheet of material; and b) a second fastener positioned between said first center fold line and said bottom edge; said second fastener including a second mount portion and two bendable arms connected to and extending from said second mount; said two bendable arms spaced from said first center fold line and said bottom edge; said two bendable arms of said second fastener located above said top surface of said sheet of material.

7. The sheet for a folder as defined in claim 1, further including a second center fold line; said second center fold line spaced from said first center fold line; said second center fold line positioned generally parallel to said first center fold line; said second center fold line extending between said first and second side edges; said second center fold line positioned generally parallel to one or both of said top and bottom edges; said second center fold line spaced from said top edge a distance that is about 30-75% of a total distance between said top and bottom edges.

8. The sheet for a folder as defined in claim 6, further including a second center fold line; said second center fold line spaced from said first center fold line; said second center fold line positioned generally parallel to said first center fold line; said second center fold line extending between said first and second side edges; said second center fold line positioned generally parallel to one or both of said top and bottom edges; said second center fold line spaced from said top edge a distance that is about 30-75% of a total distance between said top and bottom edges.

9. The sheet for a folder as defined in claim 7, wherein said second center fold line is formed of at least one depression and/or serrated region that is located on both said top and bottom surfaces of said sheet of material.

10. The sheet for a folder as defined in claim 8, wherein said second center fold line is formed of at least one depression and/or serrated region that is located on both said top and bottom surfaces of said sheet of material.

11. The sheet for a folder as defined in claim 1, wherein said sheet is made from a single piece of material and from a single die cut.

12. The sheet for a folder as defined in claim 10, wherein said sheet is made from a single piece of material and from a single die cut.

13. A kit, comprising:
one or more sheets of material for a folder; each of said sheets of material are in accordance with claim 1; and
instructions for a) folding at least one of said sheets of material along a center fold line to form a folder, and b) folding at least one of said sheet along said first side fold line prior to folding at least one of said sheets of material along a center fold line to form a folder.

14. A kit, comprising:
one or more sheets of material for a folder; each of said sheets of material are in accordance with claim 12; and
instructions for a) folding at least one of said sheets of material along a center fold line to form a folder, and b) folding at least one of said sheet along said first side fold line prior to folding at least one of said sheets of material along a center fold line to form a folder.

15. A method for forming a folder comprising:
providing a sheet of material; said sheet of material having a top surface, a bottom surface, top and bottom edges, first and second side edges, and first and second tabs; said first tab located on said top edge and said second tab located on said bottom edge; said sheet of material including a first center fold line extending between said first and second side edges; said first center fold line positioned generally parallel to one or both of said top and bottom edges; said first center fold line spaced from said top edge a distance that is about 30-75% of a total distance between said top and bottom edges; said sheet of material including a first side fold line that extends between said top and bottom edges; said first center fold line intersecting said first enter fold line at a location that is spaced from said second side edge; said first side fold line positioned generally parallel to one or both of said first and second side edges; said first side fold line positioned closer to said second side edge than to said first side edge; said first side fold line spaced from said second side edge a distance that is about 5-40% of a total distance between said first and second side edges;
folding said sheet of material along said first center fold line to form said folder.

16. The method as defined in claim 15, further including the step of folding said sheet of material along said first side fold line prior to folding said folder along said first center fold line.

17. The method as defined in claim 15, wherein a) said first center fold line is formed of at least one depression and/or serrated region that is located on both said top and bottom surfaces of said sheet of material; and/or b) said first side fold line is formed of at least one depression and/or serrated region that is located on one or both said top and bottom surfaces of said sheet of material.

18. The method as defined in claim 15, further including one or more of a) a first fastener positioned between said first center fold line and said top edge; said first fastener including a first mount portion and two bendable arms connected to and extending from said first mount; said two bendable arms spaced from said first center fold line and said top edge; said two bendable arm of said first fastener located above said top surface of said sheet of material; and b) a second fastener positioned between said first center fold line and said bottom edge; said second fastener including a second mount portion and two bendable arms connected to and extending from said second mount; said two bendable arms spaced from said first center fold line and said bottom edge; said two bendable arms of said second fastener located above said top surface of said sheet of material.

19. The method as defined in claim 15, further including a second center fold line; said second center fold line spaced from said first center fold line; said second center fold line positioned generally parallel to said first center fold line; said second center fold line extending between said first and second side edges; said second center fold line positioned generally parallel to one or both of said top and bottom edges; said second center fold line spaced from said top edge a distance that is about 30-75% of a total distance between said top and bottom edges; said second center fold line is formed of at least one depression and/or serrated region that is located on both said top and bottom surfaces of said sheet of material.

20. The method as defined in claim 15, wherein said sheet is made from a single piece of material and from a single die cut.
